(19) United States
(12) Patent Application Publication
(10) Pub. No.: US 2013/0127799 A1
(43) Pub. Date: May 23, 2013

(54) Display Device Having a Rollable Display Unit

(71) Applicant: Sang-Wol Lee, Yongin-City (KR)

(72) Inventor: Sang-Wol Lee, Yongin-City (KR)

(73) Assignee: SAMSUNG DISPLAY CO., LTD., Yongin-City (KR)

(21) Appl. No.: 13/565,501

(22) Filed: Aug. 2, 2012

(30) Foreign Application Priority Data
Nov. 18, 2011 (KR) 10-2011-0120919

(51) Int. Cl. G09G 5/00

(52) U.S. Cl. 345/204

(57) ABSTRACT

A display device comprises: a rollable display unit including a main body portion for displaying an image and a bonding portion formed on one edge of the main body portion; a driving integrated circuit chip mounted on the bonding portion of the rollable display unit; a roller unit including a cylindrical roller main body on which the rollable display unit is rolled up, and a roller pad formed at one portion of the cylindrical roller main body and coupled to the bonding portion of the rollable display unit; and a cable having one side connected to the roller pad through the interior of the cylindrical roller main body.

### CLAIM OF PRIORITY

This application makes reference to, incorporates the same herein, and claims all benefits accruing under 35 U.S.C. §119 from an application earlier filed in the Korean Intellectual Property Office on the 18 of Nov. 2011 and there duly assigned Serial No. 10-2011-0120919.

### BACKGROUND OF THE INVENTION

1. Field of the Invention

The present invention relates generally to a display device and, more particularly, to a display device having a display unit which can be rollable.

2. Description of the Related Art

As electronic devices have been reduced in size with enhanced processing power, portability of electronic devices has been drastically increased. Small display devices allow users to carry a device, such as a mobile phone, a music player, a game machine, a digital camera, a satellite reception location exploration device, or the like, to any location and use it.

However, most devices use a display with a generally inflexible glass substrate, which presents a problem in that the size and shape of devices are limited by the display. Such a display is also voluminous and easily damaged.

The above information disclosed in this Background section is only for enhancement of an understanding of the background of the described technology, and therefore it may contain information that does not form the prior art that is already known in this country to a person of ordinary skill in the art.

### SUMMARY OF THE INVENTION

The present invention has been developed in an effort to provide a display device having the advantages of being effectively rollable, being easily assembled, and preventing components thereof from being damaged in the process of rolling and unrolling.

An exemplary embodiment of the invention provides a display device comprising: a rollable display unit including a main body portion displaying an image and a bonding portion formed on one edge of the main body portion; a driving integrated circuit chip mounted on the bonding portion of the display unit; a roller unit including a cylindrical roller main body on which the display unit is rolled up and a roller pad formed at one portion of the roller main body and coupled with the bonding portion of the display unit; and a cable having one side connected to the roller pad through the interior of the roller main body.

The roller pad may be formed on a region of the roller main body which is depressed so as to be flat.

The depressed portion of the roller main body may provide an escape space so as to prevent the driving integrated circuit chip from colliding with the display unit while the display unit is being rolled or unrolled.

The roller pad and the bonding portion of the display unit may be coupled through an anisotropic conductive film (ACF).

The display device may further include a circuit board connected to the other side of the cable.

The display device may further include a driving motor coupled to one end portion of the roller main body so as to rotate the roller main body.

The display device may further include a battery for supplying power to the display unit.

The display device may further include a housing for accommodating the display unit and the roller unit.

In the display device, the display unit may include an organic light emitting element.

According to an embodiment of the invention, the display device can be effectively rollable, can be easily assembled, and can prevent a component from being damaged in the process of rolling and unrolling.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, in which like reference symbols indicate the same or similar components, wherein:

FIG. 1 is a perspective view of a display device according to an embodiment of the invention.

FIG. 2 is an exploded perspective view of the display device of FIG. 1.

FIG. 3 is an exploded perspective view of a display unit and a roller unit of FIG. 2.

### DETAILED DESCRIPTION OF THE INVENTION

The present invention will be described more fully hereinafter with reference to the accompanying drawings, in which exemplary embodiments of the invention are shown. As those skilled in the art will realize, the described embodiments may be modified in various different ways, all without departing from the spirit or scope of the present invention.

It will be appreciated that drawings are schematic and are not illustrated according to scale. Relative dimensions and rates of the parts in the drawings are illustrated so as to be exaggerated or reduced in size for clarification or convenience, and arbitrary dimensions are merely illustrative, not limiting. The same reference numerals are used for the same structures, elements, or components appearing in two or more drawings so as to exhibit like characteristics.

It will be understood that, when an element is referred to as being “on” another element, it can be directly on the other element or intervening elements may also be present.

Embodiments of the present invention show ideal embodiments in detail. As a result, various modifications of explanatory diagrams are anticipated

Thus, embodiments are not limited to particular forms of the illustrated regions. For example, modifications of forms according to a fabrication are included.

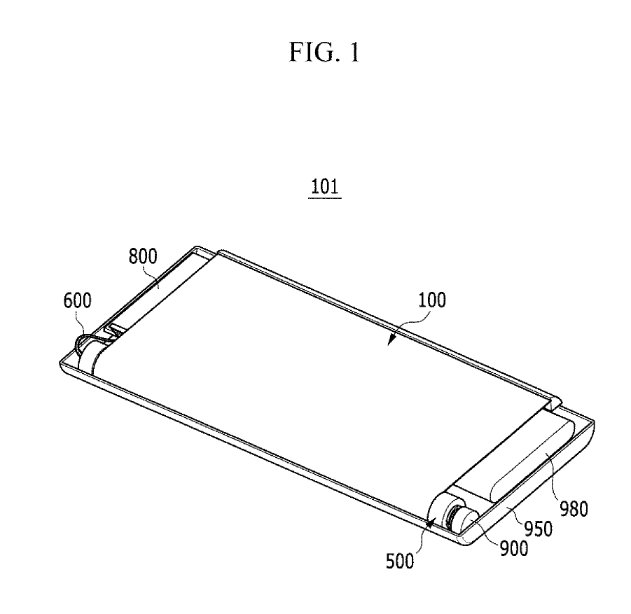

A display device according to an embodiment will now be described with reference to FIGS. 1 to 3.

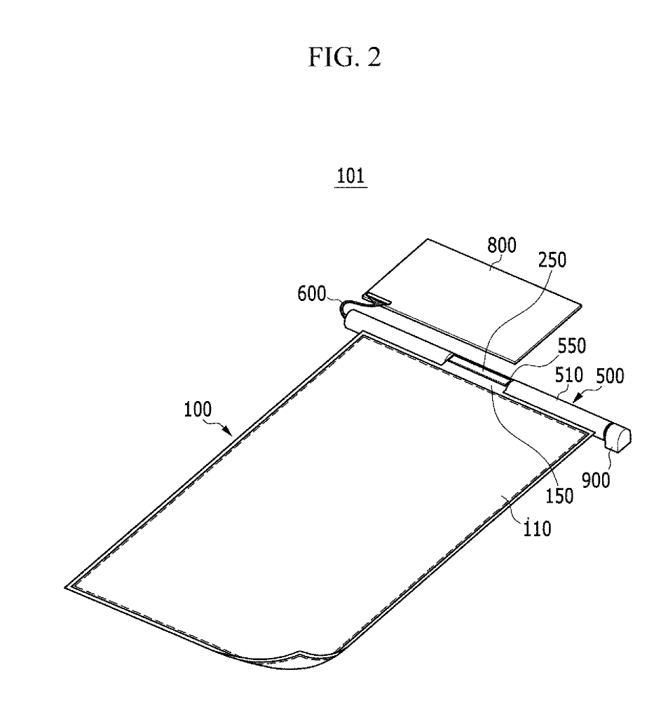

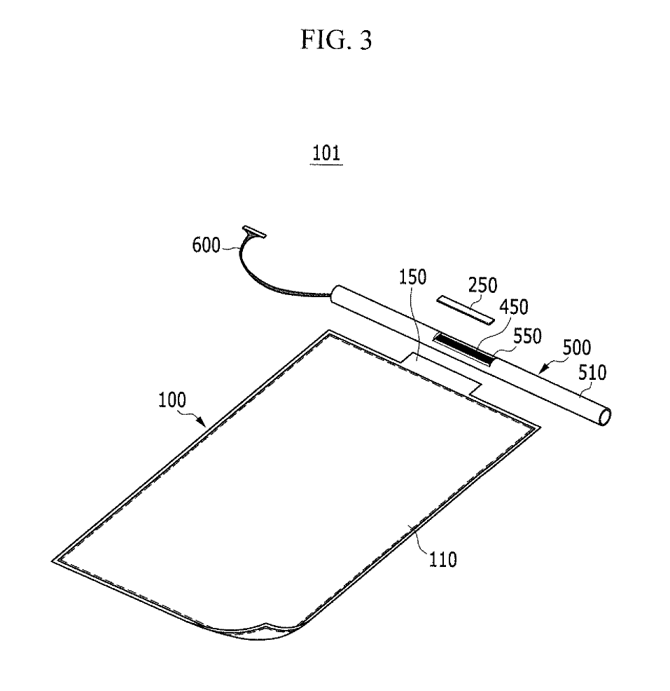

FIG. 1 is a perspective view of a display device according to an embodiment of the invention; FIG. 2 is an exploded perspective view of the display device of FIG. 1; and FIG. 3 is an exploded perspective view of a display unit and a roller unit of FIG. 2.

As shown in FIGS. 1 and 2, the display device 101 according to an embodiment of the invention includes a display unit 100, a roller unit 500, a driving integrated circuit (IC) chip 250, and a cable 600.

Also, the display device 101 according to an embodiment of the invention may further include a circuit board 800, a driving motor 900, a battery 980, and a housing 950.

In an embodiment, the display unit 100 is formed so as to be flexible, and thus rollable. Also, the display unit 100 includes an organic light emitting element. Namely, the display device 101 according to an embodiment of the invention is an organic light emitting display device. In an embodiment of the invention, the organic light emitting element included in the display unit 100 may have various structures known to a person skilled in the art.

As shown in FIG. 3, the display unit 100 includes a main body portion 110 for displaying an image and a bonding portion 150 formed at one edge of the main body portion 110. The driving IC chip 250 is mounted on the bonding portion 150 of the display unit 100.

The roller unit 500 includes a cylindrical roller main body 510, on or around which the display unit 100 is rolled, and a roller pad 550 formed in one region of the roller main body 510. The one region of the roller main body 510 on which the roller pad 550 is formed may be formed so as to be depressed, and thus flat. The bonding portion 150 of the display unit 100 is coupled to the roller pad 550 of the roller unit 500.

In this manner, the driving IC chip 250 is disposed in one depressed region of the roller main body 510. Thus, when the display unit 100 is being rolled or unrolled by the roller unit 500, the driving IC chip 250 and the display unit 100 can be stably prevented from colliding and being damaged. Namely, the depressed one region of the roller main body 510 in which the roller pad 55 is formed provides an escape space for the driving IC chip 250.

Also, the roller pad 550 of the roller unit 500 and the bonding portion 150 of the display unit 100 may be coupled through an anisotropic conductive film (ACF) 450.

As illustrated in FIG. 2, one end of the cable 600 is connected to the roller pad 550 through the interior of the roller main body 550. The other side of the cable 600 is connected to the circuit board 800. The circuit board 800 includes various circuit elements and supplies signals and power to the display unit 100.

The driving motor 900 is coupled to one end portion of the roller main body 510 of the roller unit 500 so as to rotate the roller main body 510. In the display device 101 according to an embodiment of the invention, the roller main body 510, while being rotated by the driving motor 900, can roll or unroll the display unit 100. Also, the driving motor 900 is connected to the circuit board 800 and is controlled by the circuit board 800.

As illustrated in FIG. 1, the battery 980 is connected to the circuit board 800 and supplies power to the display unit 100 or the driving motor 900.

The housing 950 may accommodate the display unit 100, the roller unit 500, the driving motor 900, the circuit board 800, the battery 980, and the like.

With such a configuration, the display device 101 according to an embodiment of the invention can be effectively rollable, can be easily assembled, and can prevent a component from being damaged in the process of rolling and unrolling.

In detail, since the roller pad 550 (FIGS. 2 and 3) of the roller unit 500, to which the bonding portion 150 of the rollable display unit 100 is coupled, is formed in a portion formed by indenting (or depressing) one region of the roller main body 510 such that it is flat. The bonding portion 150 and the roller pad 550 can be stably connected, and since the escape space is provided to the driving IC chip 250 mounted on the bonding portion 150, the driving IC chip 250 and the display unit 100 can be stably prevented from colliding and being damaged while the display unit 100 is being rolled or unrolled by the roller unit 500.

Also, according to an embodiment of the invention, in the display device 101, the display unit 100 can be easily rolled and unrolled by using the driving motor 900.

While this disclosure has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A display device, comprising:
a rollable display unit including a main body portion for displaying an image and a bonding portion formed on one edge of the main body portion;
a driving integrated circuit chip mounted on the bonding portion of the rollable display unit;
a roller unit including a cylindrical roller main body on which the rollable display unit is rolled up, and a roller pad formed at one portion of the roller main body and coupled to the bonding portion of the rollable display unit; and
a cable having one side connected to the roller pad through an interior of the cylindrical roller main body.

2. The display device of claim 1, wherein the roller pad is formed in a region of the cylindrical roller main body, said region being depressed so as to be flat.

3. The display device of claim 2, wherein the depressed region of the cylindrical roller main body provides an escape space for preventing the driving integrated circuit chip from colliding with the rollable display unit while the rollable display unit is being rolled and unrolled.

4. The display device of claim 1, wherein the roller pad of the roller unit and the bonding portion of the rollable display unit are coupled through an anisotropic conductive film (ACF).

5. The display device of claim 1, further comprising a circuit board connected to another side of the cable.

6. The display device of claim 1, further comprising a driving motor coupled to one end portion of the cylindrical roller main body for rotating the cylindrical roller main body.

7. The display device of claim 1, further comprising a battery for supplying power to the rollable display unit.

8. The display device of claim 1, further comprising a housing for accommodating the rollable display unit and the roller unit.

9. The display device of claim 1, wherein the rollable display unit comprises an organic light emitting element.
